(19) United States
(12) Patent Application Publication
(10) Pub. No.: US 2021/0361114 A1
(43) Pub. Date: Nov. 25, 2021

(54) OVEN TILE FLOOR SYSTEM AND METHOD

(71) Applicant: Gozney Group Ltd, Christchurch Dorset (GB)

(72) Inventor: Thomas Robert Llewelyn GOZNEY, Dorset (GB)

(21) Appl. No.: 16/981,901

(22) PCT Filed: Mar. 18, 2019
(86) PCT No.: PCT/GB2019/050750

§ 371 Date: Sep. 17, 2020

(30) Foreign Application Priority Data
Mar. 19, 2018 (GB) 1804348.9

(51) Int. Cl. A47J 37/06; A21B 3/00

(52) U.S. Cl. CPC A47J 37/0664; A47J 37/0658; A21B 3/00

(57) ABSTRACT

An oven floor system for tiling an oven floor surface comprises a plurality of tiles each having an underside and a plurality of support elements. Undersides of the tiles each comprise a plurality of recesses for housing support elements. When in use the undersides of the tiles are spaced from the surface by the support elements.

The present invention relates to an oven tile floor system and method.

Pizza oven floors are constructed using a plurality of tiles, commonly of a material having high thermal mass. The tiles of a pizza oven floor are carefully levelled on a bed of cement so as to provide a smooth, planar and stationary cooking surface.

Cast floor tiles have varying thickness caused by having an open ended tool that is hand-trowelled during the casting process.

The varying thickness of tiles combined with the varying thickness of cement that supports that tiles and retains them in place means that laying a tile floor of a pizza oven is a time-consuming and skilled task.

Ensuring that tiles of a pizza oven floor are all level is particularly important so as to avoid food debris collecting in the oven and to avoid cooking implements snagging on tile edges.

Furthermore, owing to particulate salt falling into gaps between tiles (formed as the tiles expand and contract owing to heating and cooling) damage to the pizza oven floor and consequently the overall structure of the oven can occur.

Once salt has fallen into a gap it prevents adjacent tiles from expanding into the gap as the tiles heat up, leading to expansion in other directions. In turn once a tile next to a gap contracts the gap can be widened and additional salt may fall into the gap worsening the problem.

The present invention seeks to improve upon the prior art.

According to a first aspect of the present invention there is provided an oven tile floor system for tiling an oven floor surface, the system comprising:
a plurality of support elements;
a plurality of tiles; wherein:
undersides of the tiles each comprise a plurality of recesses for housing support elements, and when in use the undersides of the tiles are spaced from the surface by the support elements.

By providing a plurality of supports for tiles the tiles may be spaced a uniform distance from the surface upon which the floor is laid. Advantageously by supporting the tiles on support elements expansion and contraction of the tiles with heating and cooling of the oven is more readily accommodated.

Furthermore, by spacing tiles from the floor surface any debris (in particular salt) that may fall into a gap that appears between adjacent tiles is allowed to pass between the tiles such that it falls to rest upon the surface that is beneath the tiles. Thus, such debris does not remain stuck between adjacent tiles and does not damage the overall tile structure.

A plurality of recesses may be employed to properly locate supports under tiles and hinder or prevent movement of the supports relative to the tiles.

Preferably the recesses are arranged around a periphery of the undersides of the tiles.

Preferably when in use a plurality of recesses on adjacent tiles together house a support element.

By arranging recesses around the periphery of tiles more than one tile may be supported by a single support.

In some embodiments recesses on adjacent tiles together form a housing that substantially tessellates with a support element.

In some embodiments recesses on adjacent tiles together form a substantially snug housing for a support element.

In some embodiments recesses on adjacent tiles form a housing that provides a peripheral gap of between 1 and 5 mm around a support element, or a gap of between 2 and 4 mm around a support element, or a gap of around 3 mm around a support element.

In some embodiments recesses are located at each corner of a tile.

By arranging recesses at the corners of tiles the maximum number of tiles may be supported by a single support.

In some embodiments recesses are located at each side of a tile.

In some embodiments a tile is substantially rectangular and comprises four recesses, or is substantially triangular and comprises three recesses.

In some embodiments a recess is substantially in the shape of a sector of a circle or is substantially in the shape of a quadrant.

In some embodiments a support element is substantially cylindrical or is substantially cuboid.

In some embodiments sides of tiles are shaped such that a channel extending to the underside of the tiles is formed between adjacent tiles when adjacent tiles abut each other adjacent their upper surfaces.

In some embodiments when tiles are laid flat sides of tiles are inwardly angled to the vertical.

In some embodiments when tiles are laid flat sides of tiles are inwardly angled at between 1 and 10 degrees to the vertical, or are inwardly angles at between 2 and 8 degrees to the vertical or are inwardly angled at between 3 and 6 degrees to the vertical or are inwardly angled at between 4 and 5 degrees to the vertical.

In some embodiments respective portions of adhesive are positioned between the underside of the tiles and the surface.

In some embodiments a support comprises at least one line of weakness such that the support may be separated into halves or a support comprises two lines of weakness such that the support may be separated into quarters.

According to a third aspect of the present invention there is provided a tile adapted for use with the system of any preceding statement of invention relating to the first aspect of the present invention.

According to a third aspect of the present invention there is provided a method of constructing an oven tile floor on an oven floor surface comprising the steps of:
i) providing a system in accordance with any preceding statement of invention relating to the first aspect of the present invention;
ii) positioning a plurality of tiles adjacent each other such that the tiles rest on a plurality of support elements and are spaced from the surface.

In some embodiments the method comprises the further step of applying adhesive between the undersides of the tiles and the surface so as to attach the tiles to the surface.

In order that the present invention may be more fully understood a specific embodiment will now be described by way of example with reference to the accompanying schematic drawings, of which:

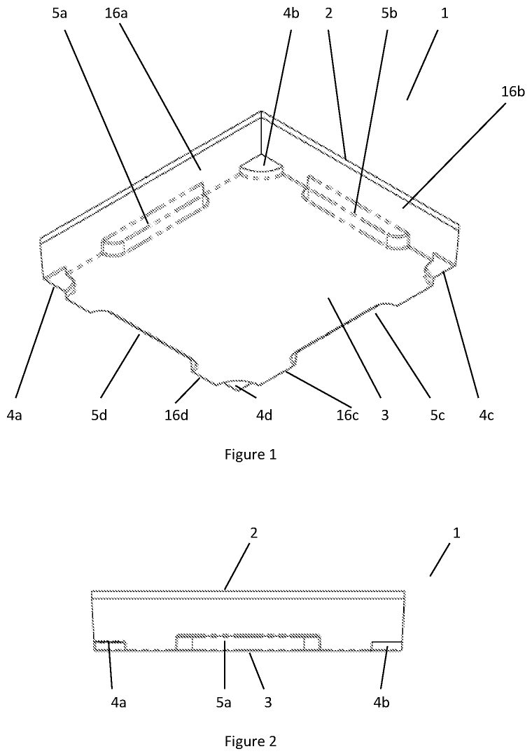

FIG. 1 is a perspective view of the underside of a tile made in accordance with the present invention;

FIG. 2 is a side view of the tile of FIG. 1;

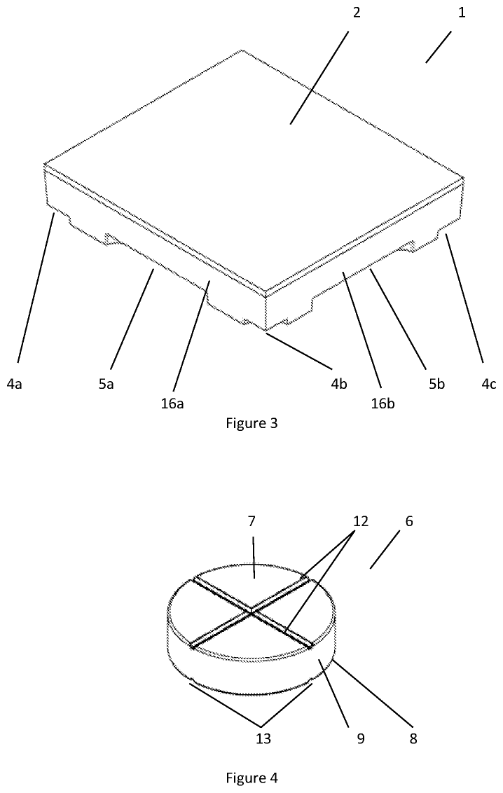

FIG. 3 is a perspective view of the top of the tile of FIG. 1;

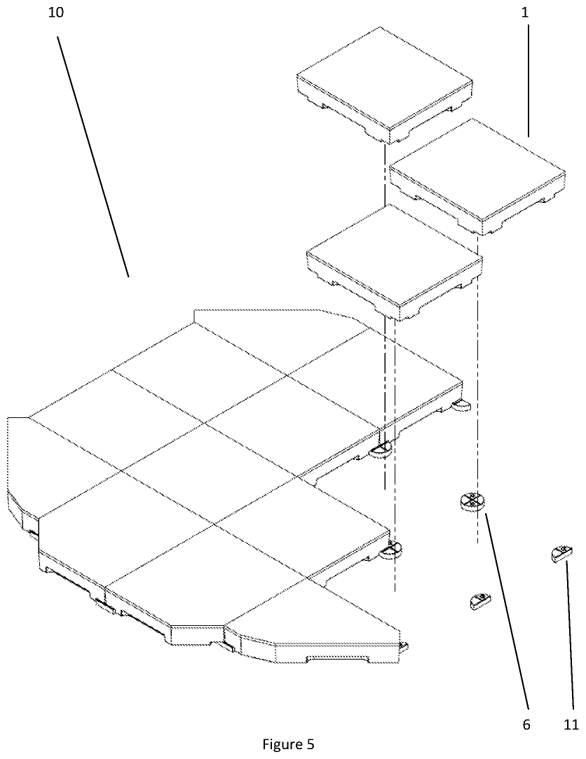

FIG. 4 is a perspective view of a support element for use with the tile of FIG. 1; and

FIG. 5 is a perspective view illustrating how a tile floor made in accordance with the system of the present invention is constructed.

Referring to FIG. 1, an oven floor tile 1 is substantially rectangular.

Tile 1 comprises a substantially planar upper side 2 and a substantially planar underside 3. When in use upper side 2 of tile 1 forms part of the surface of a floor of a pizza oven (not shown).

Tiles 1 are manufactured in a two part mould, which beneficially means that the thickness and profile of the tiles is substantially uniform. The tolerance of the dimensions of tile 1 are approximately +/−0.2 mm. Underside 3 represents the ‘fill face’ where material is poured into the mould.

Underside 3 comprises at its four corners four respective recesses 4a, 4b, 4c, 4d, each of which are each substantially in the shape of a quadrant. The spacing of recesses 4a, 4b, 4c, 4d, from the planar upper side 2 of tile 1 is precisely controlled during the manufacturing process. This is contrast to the uniformity of underside 3, which may be relatively rough.

Underside 3 also comprises along its four edges four respective recesses 5a, 5b, 5c, 5d, which are substantially cuboid in shape. Recesses 5a, 5b, 5c, 5d are distinct from recesses 4a, 4b, 4c, 4d. Recesses 5a, 5b, 5c, 5d are provided to assist a user in handling tile 1 when installing tile 1 in a pizza oven.

Turning to FIG. 4, a support 6 is substantially cylindrical having a substantially planar circular upper side 7 and a substantially planar circular underside 8 with a circular side wall 9 extending between upper side 7 and underside 8.

Support 6 is formed of a ceramic material.

The radius of support 6 substantially corresponds to the radius embodied in each of the four quadrant shaped recesses 4a, 4b, 4c, 4d.

Height of support 6, i.e. the distance along circular side wall 9 between upper side 7 and underside 8, is less than the depth of recesses 4a, 4b, 4c, 4d, such that when support 6 is housed within one of recesses 4a, 4b, 4c, 4d underside 8 of support 6 stands proud of underside 3 of tile 1.

Upper side 7 comprises two linear diametric grooves 12 in the form of a cross. Similarly underside 8 comprises two linear diametric grooves 13 in the form of a cross.

Together grooves 12 and 13 allow support 6 to be broken into two semi circular supports 11 and each semicircular support 11 further broken into two quadrant-shaped supports (not shown). A support 6 may be readily snapped into semicircles and quadrants by using a chisel or flat head screwdriver.

Supports 6 are sized such that when in use adjacent tiles 1 abut each other. Supports 6 are slightly smaller than the space formed by four quadrant shaped recesses 4a, 4b, 4c, 4d such that a peripheral gap 15 of around 2.5 mm exists around support 6 when tiles 1 abut each other and support 6 is centrally housed within a cylindrical recess.

In other embodiments recesses may form a housing that provides a peripheral gap of between 1 and 5 mm around a support element, or a gap of between 2 and 4 mm around a support element, or a gap of around 3 mm around a support element.

Provision of a small gap around support elements accommodates any movement of tiles supported thereon as the oven heats and cools.

Turning to FIG. 5 and an illustration of the floor system of the present invention in use, an oven floor 10 may be constructed using a plurality of tiles 1 and a plurality of supports 6.

Typically a pizza oven floor 10 is constructed on a substantially planar layer of an insulating material.

In order to construct oven floor 10 in accordance with the present invention a user rests a tile 1 upon four supports 6, which are housed within the four respective recesses 4a, 4b, 4c, 4d located at the corners of tile 1.

Adjacent tiles 1 may be laid such that a single support 6 is supporting four adjacent tiles at their corners.

When in use a tile 1 resting upon four supports 6 that are housed in respective recesses 4a, 4b, 4c, 4d is spaced from a surface upon which the four supports rest.

In this manner a suspended pizza oven floor 10 is constructed with tiles 1 being spaced from the surface upon which floor 10 is constructed by supports 6.

Tiles are held in place upon the surface by small amounts of adhesive in the form of cement (not shown) applied to the centre of the underside of tiles 1 prior to a tile 1 being laid.

Beneficially providing cement under tiles 1 also assists in supporting the weight of the tiles (as opposed to the tiles resting solely on supports 6).

Advantageously in contrast to prior art floors in the system of the present invention tiles 1 are supported by supports 6 such that tiles 1 are uniformly spaced from the surface upon which the oven floor is constructed.

Thus, tiles 1 form a continuous and smooth planar surface with the upper surfaces 2 of tiles 1 being level with the upper surfaces 2 of adjacent tiles 1.

Semicircular supports 11 may be employed to support tiles at the edge of pizza oven floor 10 and quadrant-shaped supports (not shown) may be employed at the corners of a pizza oven floor.

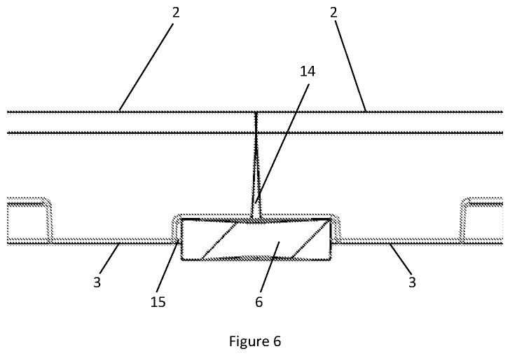

Turning to FIG. 6 it may be seen that when tile 1 is laid flat edge sides 16a, 16b, 16c, 16d of tiles 1 are inwardly inclined at approximately 3 degrees to the vertical such that the upper side 2 of a tile 1 extends out above the underside 3 of tile 1. That is to say that edge sides 16a, 16b, 16c, 16d of tile 1 are angled to the plane of upper surface 2 at an angle of around 87 degrees.

Although in the present embodiment edge sides 16a, 16b, 16c, 16d are angled to the plane of upper surface 2 at an angle of around 87 degrees in other embodiments other angles may be employed. For example in other embodiment edge sides 16a, 16b, 16c, 16d may be angled to the plane of upper surface 2 by between 89 and 80 degrees, between 88 and 82 degrees, between 87 and 84 degrees or between 86 and 85 degrees.

This results in a channel 14 that is substantially in the form of a triangular prism being formed between tiles 1 when tiles 1 abut each other adjacent their upper sides 2. In a first plane channel 14 extends alongside the edge of tiles 1 and in an orthogonal plane channel 14 extends from an apex adjacent upper sides 2 of tiles 1 down to a debris outlet adjacent undersides 3 of tiles 1.

Channel 14 does not normally provide a through-channel between the upper sides 2 of tiles 12 and the undersides 3 owing to adjacent tiles normally abutting each other adjacent their upper sides. Channel 14 is normally sealed at its upper end adjacent upper sides 2 of adjacent tiles 1.

However, channel 14 is operable to remove debris from between tiles should a gap open up between adjacent tiles 1 so as to provide access to channel 14. In this instance channel 14 allows for any debris that falls between tiles 1 to drop through channel 14 such that debris rests on the surface that supports 6 stand (instead of the debris being trapped between the tiles and thereby causing damage to the tile structure). Beneficially as channel 14 widens towards the undersides of tiles 1 debris does not become stuck between adjacent tiles as it falls.

In the present embodiment the term rectangular is intended to include a square.

It will be apparent that support-housing recesses on tiles need not be formed at corners but could be formed at the edges of tiles.

It will also be apparent that any appropriate shape of tile may be employed.

Many variations are possible without departing from the scope of the present invention as defined in the appended claims.

For the avoidance of doubt, the present disclosure includes the subject matter recited in the appended numbered statements:

1. An oven tile floor system for tiling an oven floor surface, the system comprising:
a plurality of support elements;
a plurality of tiles; wherein
undersides of the tiles each comprise a plurality of recesses for housing support elements, and when in use the undersides of the tiles are spaced from the surface by the support elements.

2. The floor system of Statement 1 wherein the recesses are arranged around a periphery of the undersides of the tiles.

3. The floor system of Statement 1 or 2 wherein when in use a plurality of recesses on adjacent tiles together house a support element.

4. The floor system of any preceding Statement wherein recesses on adjacent tiles together form a housing that substantially tessellates with a support element.

5. The floor system of any preceding Statement wherein recesses on adjacent tiles together form a substantially snug housing for a support element.

6. The floor system of any preceding Statement wherein recesses on adjacent tiles form a housing that provides a peripheral gap of between 1 and 5 mm around a support element, or a gap of between 2 and 4 mm around a support element, or a gap of around 3 mm around a support element.

7. The floor system of any preceding Statement wherein recesses are located at each corner of a tile.

8. The floor system of any preceding Statement wherein recesses are located at each side of a tile.

9. The floor system of any preceding Statement wherein a tile is substantially rectangular and comprises four recesses or is substantially triangular and comprises three recesses.

10. The floor system of any preceding Statement wherein a recess is substantially in the shape of a sector of a circle or is substantially in the shape of a quadrant.

11. The floor system of any preceding Statement wherein a support element is substantially cylindrical or is substantially cuboid.

12. The floor system of any preceding Statement wherein sides of tiles are shaped such that a channel extending to the underside of the tiles is formed between adjacent tiles when adjacent tiles abut each other adjacent their upper surfaces.

13. The floor system of Statement 12 wherein when tiles are laid flat sides of tiles are inwardly angled to the vertical.

14. The floor system of Statement 12 or 13 wherein when a tile is laid flat sides of tiles are inwardly angled at between 1 and 10 degrees to the vertical, or are inwardly angled at between 2 and 8 degrees to the vertical or are inwardly angled at between 3 and 6 degrees to the vertical or are inwardly angled at between 4 and 5 degrees to the vertical.

15. The floor system of any preceding Statement wherein respective portions of adhesive are positioned between the underside of the tiles and the surface.

16. The floor system of any preceding Statement wherein a support comprises at least one line of weakness such that the support may be separated into halves or a support comprises two lines of weakness such that the support may be separated into quarters.

17. A tile adapted for use with the system of any preceding Statement.

18. A method of constructing a tile floor on an oven floor surface comprising the steps of:
i) providing a system in accordance with any of Statements 1 to 16;
ii) positioning a plurality of tiles adjacent each other such that the tiles rest on a plurality of support elements and are spaced from the surface.

19. The method of Statement 18 comprising the further step of applying adhesive between the undersides of the tiles and the surface so as to attach the tiles to the surface.

1. An oven tile floor system for tiling an oven floor surface, the system comprising:
a plurality of support elements;
a plurality of tiles; wherein
undersides of the tiles each comprise a plurality of recesses for housing support elements, and when in use the undersides of the tiles are spaced from the surface by the support elements.

2. The floor system of claim 1 wherein the recesses are arranged around a periphery of the undersides of the tiles.

3. The floor system of claim 1 wherein when in use a plurality of recesses on adjacent tiles together house a support element.

4. The floor system of claim 1 wherein recesses on adjacent tiles together form a housing that substantially tessellates with a support element.

5. The floor system of claim 1 wherein recesses on adjacent tiles together form a substantially snug housing for a support element.

6. The floor system of claim 1 wherein recesses on adjacent tiles form a housing that provides a peripheral gap of between 1 and 5 mm around a support element, or a gap of between 2 and 4 mm around a support element, or a gap of around 3 mm around a support element.

7. The floor system of claim 1 wherein recesses are located at each corner of a tile.

8. The floor system of claim 1 wherein recesses are located at each side of a tile.

9. The floor system of claim 1 wherein a tile is substantially rectangular and comprises four recesses or is substantially triangular and comprises three recesses.

10. The floor system of claim 1 wherein a recess is substantially in the shape of a sector of a circle or is substantially in the shape of a quadrant.

11. The floor system of claim 1 wherein a support element is substantially cylindrical or is substantially cuboid.

12. The floor system of claim 1 wherein sides of tiles are shaped such that a channel extending to the underside of the tiles is formed between adjacent tiles when adjacent tiles abut each other adjacent their upper surfaces.

13. The floor system of claim 12 wherein when tiles are laid flat sides of tiles are inwardly angled to the vertical.

14. The floor system of claim 12 wherein when a tile is laid flat sides of tiles are inwardly angled at between 1 and 10 degrees to the vertical, or are inwardly angled at between 2 and 8 degrees to the vertical or are inwardly angled at between 3 and 6 degrees to the vertical or are inwardly angled at between 4 and 5 degrees to the vertical.

15. The floor system of claim 1 wherein respective portions of adhesive are positioned between the underside of the tiles and the surface.

16. The floor system of claim 1 wherein a support comprises at least one line of weakness such that the support may be separated into halves or a support comprises two lines of weakness such that the support may be separated into quarters.

17. A tile adapted for use with the system of claim 1.

18. A method of constructing a tile floor on an oven floor surface comprising the steps of:
i) providing a system in accordance with claim 1;
ii) positioning a plurality of tiles adjacent each other such that the tiles rest on a plurality of support elements and are spaced from the surface.

19. The method of claim 18 comprising the further step of applying adhesive between the undersides of the tiles and the surface so as to attach the tiles to the surface.
